(19) United States
(12) Patent Application Publication
(10) Pub. No.: US 2018/0320435 A1
(43) Pub. Date: Nov. 8, 2018

(54) LIGHTWEIGHT HIGH TECH DOOR

(71) Applicant: INTER-JOIN PTY LTD, Villawood, New South Wales (AU)

(72) Inventor: Tomo BERTOVIC, Villawood, New South Wales (AU)

(21) Appl. No.: 15/770,732

(22) PCT Filed: Oct. 26, 2016
(86) PCT No.: PCT/AU16/00364

§ 371 Date: Apr. 24, 2018

(30) Foreign Application Priority Data
Oct. 26, 2015 (AU) 2015101579

(51) Int. Cl. E06B 3/70

(52) U.S. Cl. CPC E06B 3/7015; E06B 3/7003; E06B 2003/7051; E06B 2003/7023; E06B 2003/703

(57) ABSTRACT

A door includes a sandwich panel having first and second panels, and a honey comb core. The first and second panels have edge tabs foldable toward one another. There are inner frame sections disposed at edge sections of the sandwich panel and adjacent to the honey comb core and inwardly of the edge tabs. The edge tabs are folded toward one another over the inner frame sections.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a door and in particular to method of forming a door that is formed entirely out of a single lightweight pre-fabricated aluminium honeycomb core panel.

### 2. Description of Related Art Including Information Disclosed Under 37 CFR 1.97 and 37 CFR 1.98

Door construction has remained the same for many years. One form comprises a perimeter structural timber frame, with a core made from honeycomb or other lightweight cardboard material. This construction provides rigidity whist being relatively light. The inner core material is typically covered with timber veneer or MDF panels that are suitable for staining or painting. In recent years, pre-finished material has been used for door surfaces, however by way of construction, the door ends are exposed in the raw state requiring further finishing.

By way of installation, all doors have only three visible surfaces, being the internal face of the door from inside the room, the external face from outside the room and the latched face. The top of the door and the bottom of the door are never visible on an installed door.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a door comprising:
a sandwich panel comprising a first panel, a second panel, and a honeycomb core extending between inner surfaces of the first and second panels, the first and second panels having edge tabs foldable towards each other,
inner frame sections disposed at edge sections of the sandwich panel adjacent the honeycomb core and inwardly of the edge tabs, and
wherein the edge tabs are folded towards each other over the inner frame sections.

In a preferred embodiment, fold grooves are formed into the inner surfaces of the first and second panels at the edge sections thereof, the fold grooves being spaced inwardly from edges of the first and second panels and defining the edge tabs in the first and second panels.

In another preferred embodiment, each inner frame section comprises an elongated C-section beam having a central portion and upper and lower flanges, wherein the upper and lower flanges are disposed in the honeycomb core adjacent the respective first and second panels, and the central portion extends perpendicularly between the first and second panels slightly inwardly of the fold grooves.

In another preferred embodiment, the door comprises an inner frame sections comprise a hinge frame section, a latch frame section, and top and bottom frame sections.

In another preferred embodiment, the frame sections comprise mitred cut ends to meet at the corners of the door and to form an inner perimeter frame.

In another preferred embodiment, the edge tabs meet in a contiguous manner at a centre width line of the door.

In another preferred embodiment, the edge tabs comprise hinge tabs, latch tabs, upper tabs and lower tabs.

In another preferred embodiment, the latch plate tabs comprise latch deformation outlines and a latch cutout opening, wherein the deformation outlines are punched and deformed into both latch tabs to provide a recess to house a latch plate.

In another preferred embodiment, the corners of the first and second panels include shaped cut outs to provide contiguous folded edges.

In another preferred embodiment, hinge holes are formed in the hinge tabs, with hinges joining the hinge tabs to each other.

In another preferred embodiment, the hinges are attached to the inner frame section at the hinge edge.

In another preferred embodiment, the inner frame section for the latch edge comprises a step in the central portion thereof, wherein latch edge tabs of the honeycomb core cover the step.

In another preferred embodiment, the first and second panels are made from rectangular aluminium sheets.

In another preferred embodiment, the honeycomb core is made from aluminium, polyurethane foam, or polystyrene.

The present invention also provides a method of forming the door, the method comprising:
providing a sandwich panel comprising a first panel, a second panel, and a honeycomb core extending between inner surfaces of the first and second panels, the first and second panels having edge tabs foldable towards each other,
inserting inner frame sections at edge sections of the sandwich panel adjacent the honeycomb core and inwardly of the edge tabs, and
folding the edge tabs are towards each other over the inner frame sections.

In another preferred embodiment, each inner frame section comprises an elongated C-section beam having a central portion and upper and lower flanges, the method comprising removing honeycomb material for inserting the upper and lower flanges therein.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a front elevation view of a honeycomb core panel showing cut and grooved lines.

FIG. 2 is a cross-sectional view through the honeycomb core panel, showing the honeycomb core sandwiched between first and second aluminium sheets.

FIG. 3 shows the detailed sectional view of A in FIG. 1 of the door handle holes and latch plate cut out.

FIG. 4 shows the detailed sectional view of B in FIG. 1 of the grooved lines, cut lines and hinge hole locations.

FIGS. 5 to 8 are cross-section views of details of the honeycomb core panel showing the steps in the insertion of the inner frame to the edge section of the core panel and panel folds over the inner frame.

FIG. 9 is an isometric perspective view of the honeycomb core panel.

FIG. 10 shows the detailed perspective view of C in FIG. 9 showing the hinge hole locations and corner cuts for folding.

FIG. 11 is an exploded isometric perspective view of the honeycomb core panel and the inner door frame sections.

FIG. 12 is an isometric perspective view from the hinge face of the formed door with the folded panels.

FIG. 13 is an isometric perspective view similar to FIG. 12 with hinges installed to the door.

FIG. 14 shows the detailed perspective view of D in FIG. 13.

FIG. 15 is an isometric perspective view from the latch face of the formed door.

FIG. 16 shows the detailed perspective view of E in FIG. 1.

FIG. 17 is a front elevation view of an alternate honeycomb core panel for a double rebate door showing cut and grooved line.

FIG. 18 shows the detailed elevation view of F in FIG. 17 of the first (upper) panel.

FIG. 19 shows the detailed elevation of G in FIG. 17 of the second (lower) panel.

FIG. 20 shows the detailed elevation of H in FIG. 17 of the hinge face.

FIGS. 21 to 24 are cross-sectional views of details of the honeycomb core panel of FIG. 17 showing the steps in the insertion of the inner frame to the edge section of the core panel and panel folds over the inner frame.

FIG. 25 is an isometric perspective view of the honeycomb core panel of FIG. 17 showing the panel corner cuts.

FIG. 26 shows the detailed perspective view of I in FIG. 25.

FIG. 27 is an isometric perspective view of the formed alternative door.

FIG. 28 shows the detailed perspective view of J in FIG. 27.

### DETAILED DESCRIPTION OF THE INVENTION

It should be noted in the following description that like or the same reference numerals in different embodiments denote the same or similar features.

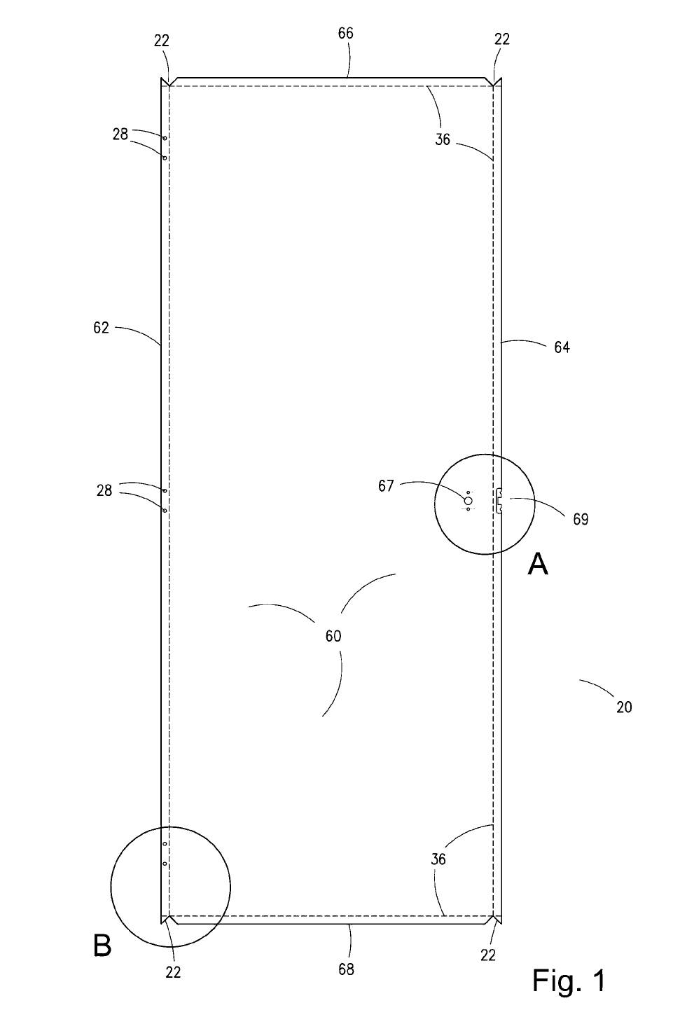

FIG. 1 shows a front view of a pre-finished aluminium honeycomb core panel 20 for a door 100 according to a preferred embodiment of the present invention.

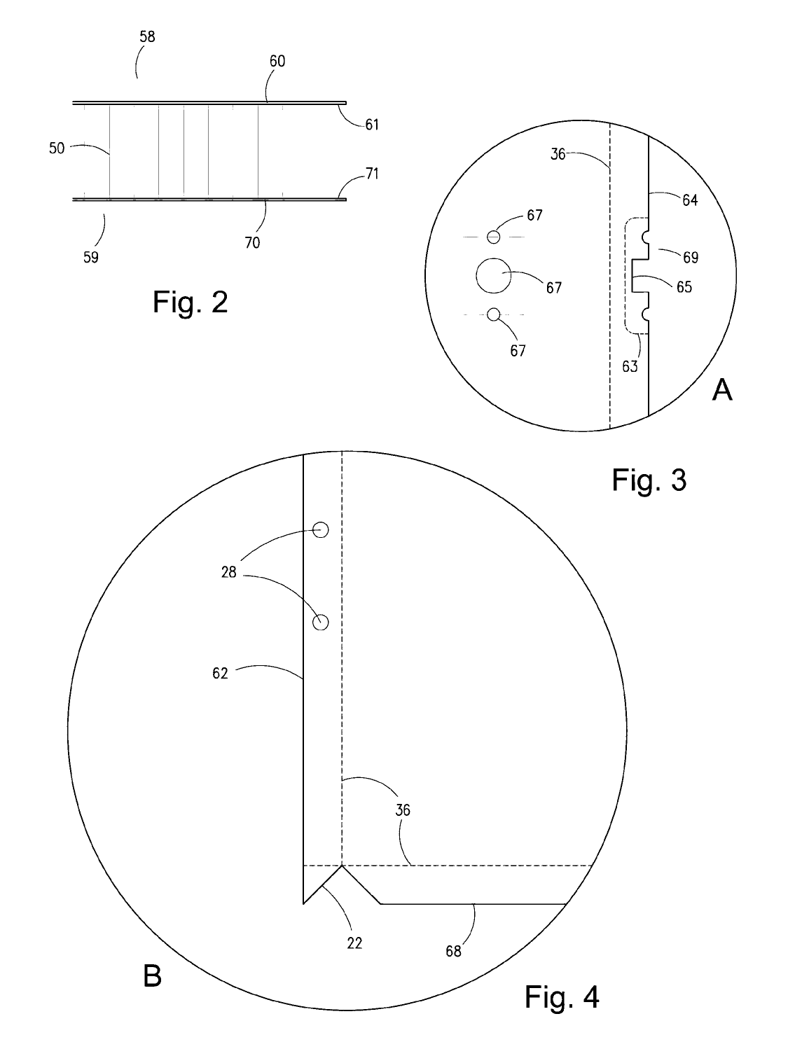

As shown in FIG. 2, the panel is a sandwich panel comprising a first panel 58, a second panel 59 and a honeycomb core 50 therebetween. The first panel 58 has an external surface 60 and an inner surface 61. The second panel 59 has an external surface 70 and an inner surface 71. The honeycomb core 50 extends between the inner surfaces 61 and 71. In the embodiment, the first and second panels 58 and 59 are made from rectangular aluminium sheets, slightly larger than the panel size of the door to be formed. The honeycomb core can be made from aluminium, polyurethane foam, polystyrene, or other suitable material.

‘V shaped grooves 36 are carved into the inner surfaces 61 and 71 of the first and second panels 58 and 59, at the edge sections thereof, to provide a guide for folding. The grooves 36 are spaced inwardly from edges of the first and second panels 58 and 59. The grooves 36 define edge tabs in the first panel 58, being a first hinge tab 62, a first latch tab 64, a first upper tab 66 and a first lower tab 68. The grooves 36 define edge tabs in the second panel 59, being a second hinge tab 72, a second latch tab 74, a second upper tab 76 and a second lower tab 78.

As shown in FIG. 3, door handle holes 67 are formed in mirrored locations of the first and second panels 58 and 59 close to the latch tabs 64. Latch plate details 69 are formed in the latch tabs 64 of the first and second panels 58 and 59. The latch plate detail 69 consists of deformation outline 63 and a latch cutout opening 65 being punched and deformed into both latch tabs 64 and 74 of the first and second panels 58 and 59.

As shown in FIG. 4, the corners of the first and second panels 58 and 59 include a triangle cut 22 and ‘V grooves 36 carved into the inner surfaces 61 and 71 to provide folding guide lines. Spaced pairs of hinge holes 28 are formed in the hinge tabs 62 and 72, with the hinge holes 28 being mirrored in the first and second panels 58 and 59.

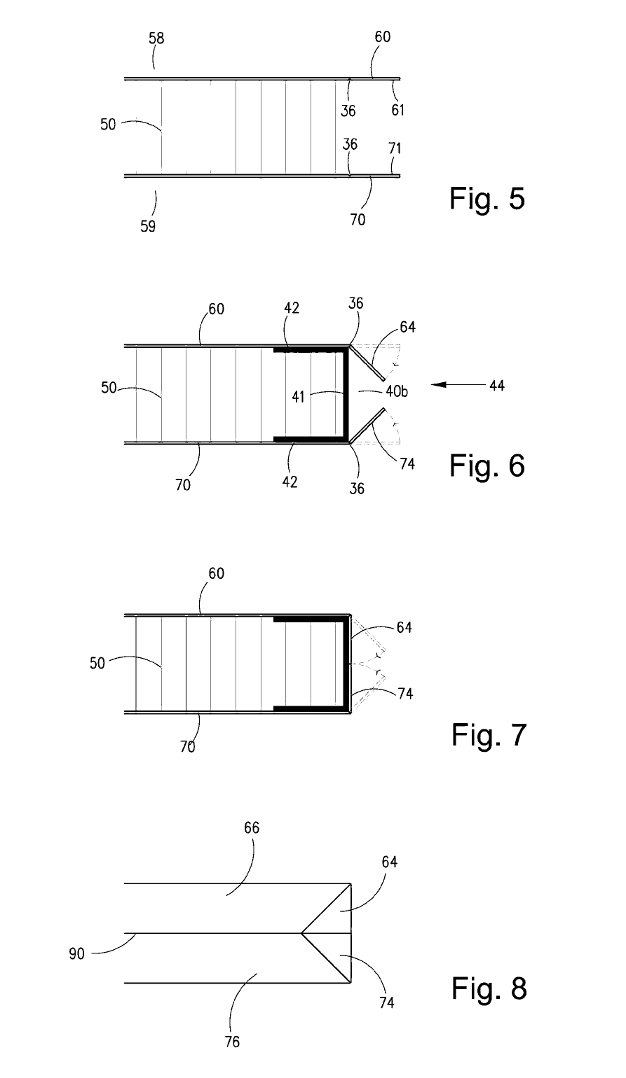

FIGS. 5 to 12 show the steps in forming the door 100, in particular the steps in the insertion of the inner frame sections 40 to the edge section of the honeycomb core panel 50 and panel folds over the inner frame sections 40.

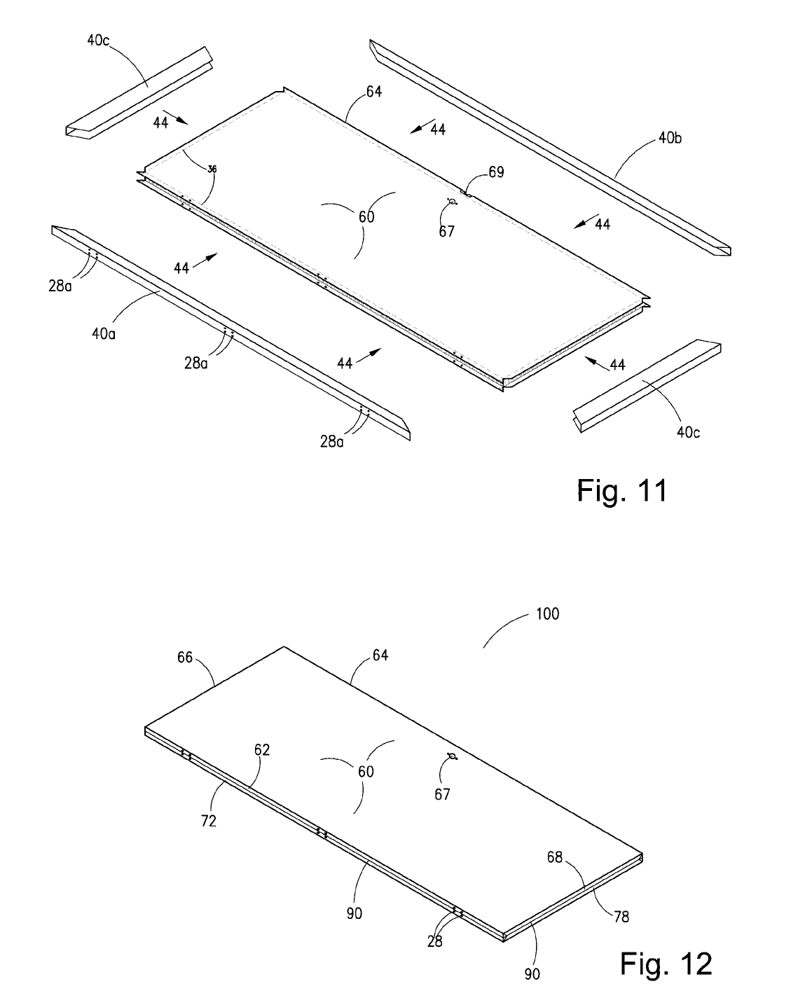

As best shown in FIG. 11, each inner frame section 40 comprises an elongated C-section beam having a central portion 41 and upper and lower flanges 42. The door 100 comprises an inner frame section 40 for each edge (hinge edge, latch edge, top and bottom edges) of the honeycomb core panel 20, being a hinge frame section 40a, a latch frame section 40b, and top and bottom frame sections 40c. The frame sections comprise mitred (45°) cut ends to meet at the corners and together form an internal perimeter frame for the door. The central portion 41 of the hinge frame section 40a includes spaced hinge holes 28a. The central portion 41 of the hinge latch section 40b includes a cutout corresponding to the latch plate cut detail 69.

The inner frame sections 40 are inserted into the respective edges (hinge edge, latch edge, top and bottom edges) of the honeycomb core panel 20, between the inner surfaces 61 and 71 of the first panel 58 and the second panel 59. Sections of the honeycomb core 50 adjacent the inner surfaces 61 and 71 are removed to allow the upper and lower flanges 42 to be inserted therein. The inner frame sections 40 are inserted such that they are disposed inwardly of the respective panel tabs (hinge tabs 62 and 72, latch tabs 64 and 74, upper tabs 66 and 76, and lower tabs 68 and 78). The central portion 41 extends perpendicularly between the first panel 58 and the second panel 59, slightly inwardly of the V-groove fold lines 36.

FIGS. 5 to 7 show the insertion of the latch frame section 40b to the latch frame edge of the honeycomb core 50. The latch tabs 64 and 74 are then folded towards each other (over and covering the central portion 41, securing latch frame section 40b to the honeycomb core 50. These steps are repeated for the other frame sections 40 into their respective edges of the honeycomb core 50.

FIG. 8 shows the folded latch tabs 64 and 74 and folded lower tabs 68 and 78. The folded tabs meet at a centre line 90 of the door edges. The triangular cut outs 22 allow the adjacent tabs to meet in a contiguous manner with no overlap.

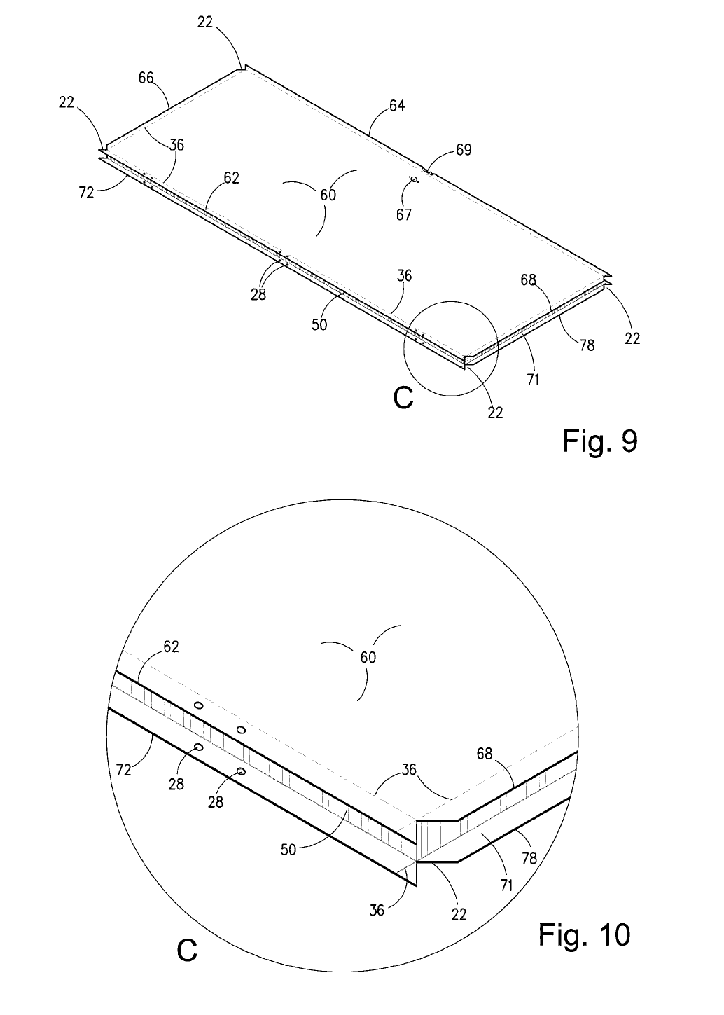

FIGS. 9 and 10 shows the honeycomb core panel 50, including the hinge hole locations 28 and corner cuts 22. Dashed lines 36 represent the ‘V shaped folding grooves, mounting holes 67 for the door hardware, latch plate cut out 69 and door hinge holes 28. The cut out portions 22 form the corner tab folds, with folds meeting at the middle 90 of the panel thickness.

FIG. 11 shows the honeycomb core 50 with inner frame sections 40 to be inserted into the honeycomb core 50 by sliding 44 into the open core. When the inner frame sections 40 are in position, upper perimeter tabs 62, 64, 66 and 68 are folded to meet lower perimeter tabs 72, 74, 76 and 78 at the middle 90 of the panel thickness.

FIG. 12 is an isometric view from the hinge face of the formed door 100 with the folded panels.

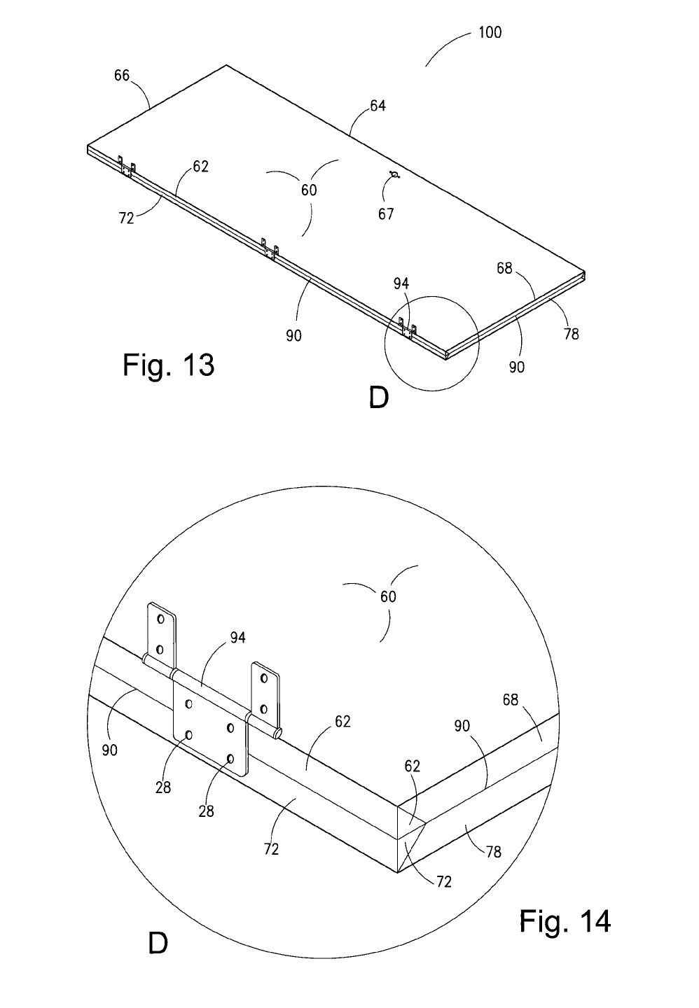

FIG. 13 is an isometric view similar to FIG. 12 with hinges 94 installed to the door 100. The hinges 94 secure the first hinge tab 62 to the second hinge tab 72, meeting at the middle 90 of the panel thickness. The hinges 94 are also secured to the inner frame section 40a.

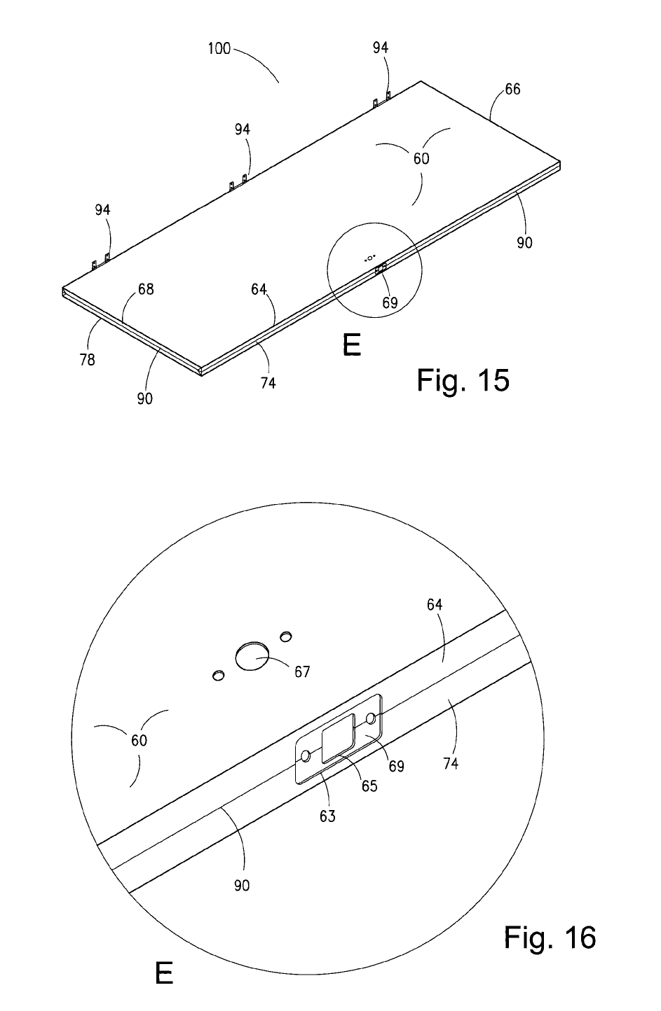

FIGS. 15 and 16 show isometric views of the door panel 100 with latch plate details 69 being located between first latch tab 64 and the second latch tab 74. The deformation outlines 63 are punched and deformed into both latch tabs 64 and 74 to provide a recess to house a latch plate. The latch plate locks the first and second panels 58 and 59 to the inner frame section 40b. The latch cutout openings 65 join to form the opening for the latch.

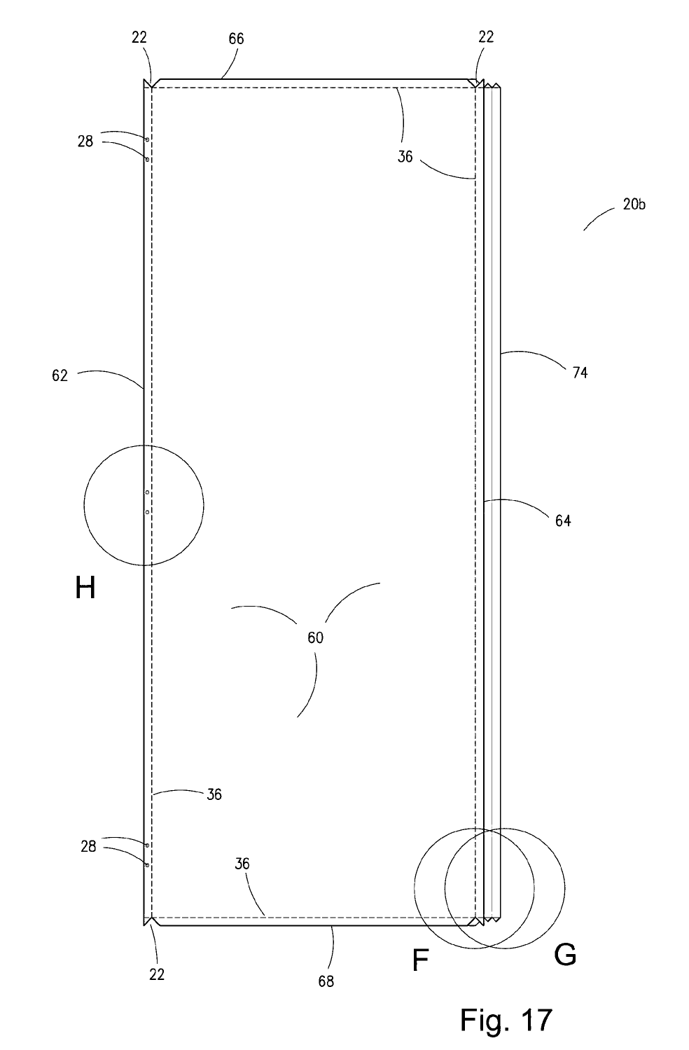

FIGS. 17 to 20 shows a pre-finished aluminium honeycomb core panel 20b for a door 100b according to an alternate embodiment of the present invention that incorporates cuts 24 and grooves and an extended second latch tab 74 to be folded for a double rebate door.

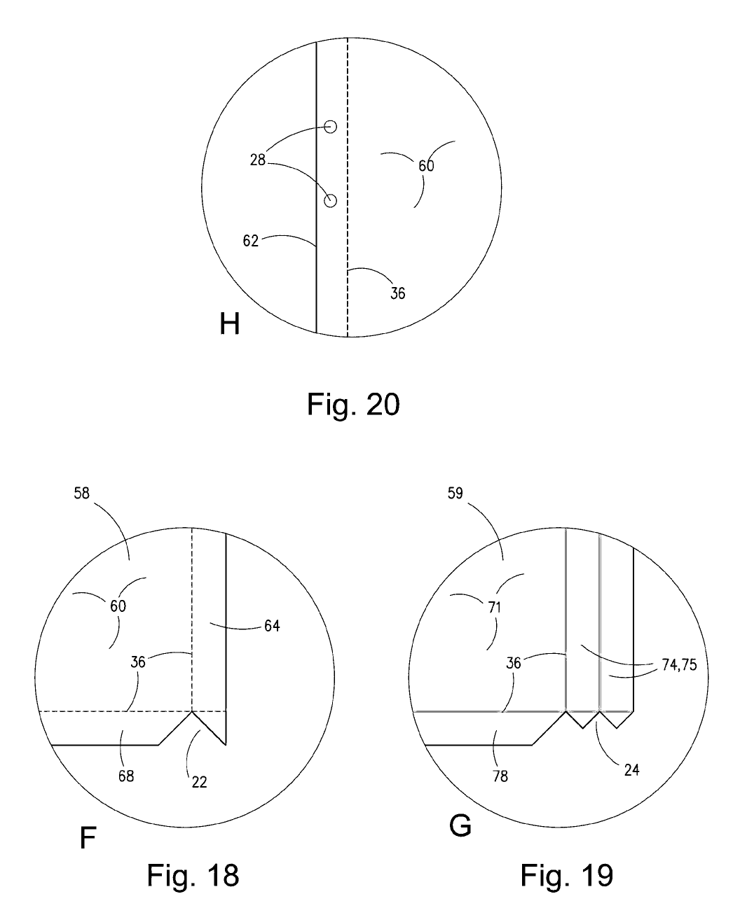

FIG. 18 shows the detail F of the first (upper) panel 58, which is similar for the honeycomb core panel 20 above. The first panel 58 includes the upper external surface 60 with corner cut 22 and internal surface ‘V grooves 36 for folding lines for the first latch tab 64 and the first lower tab 68.

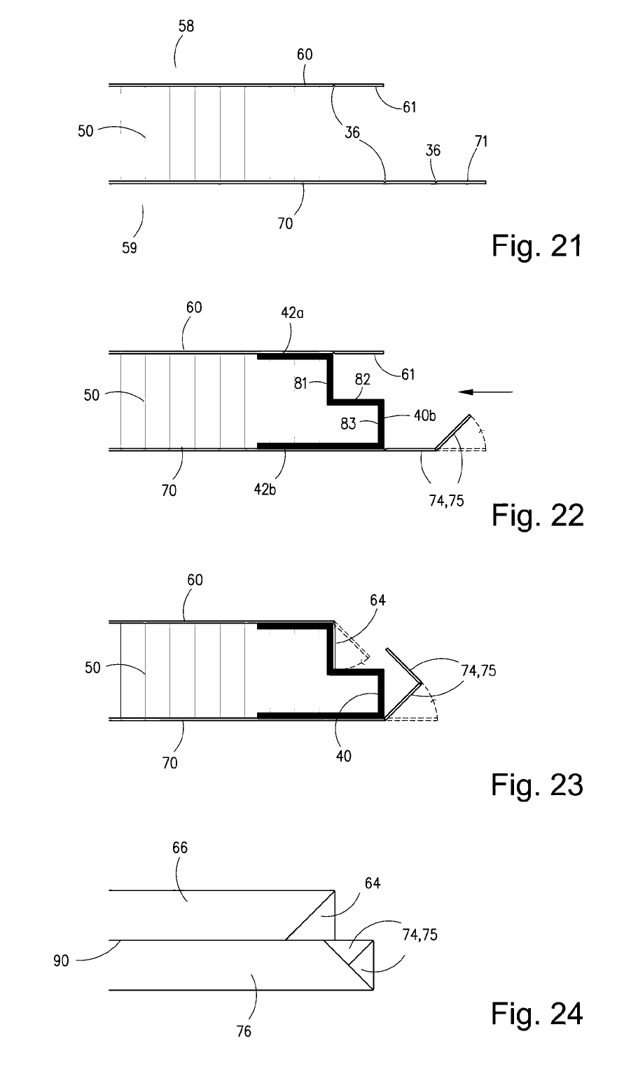

FIG. 19 shows the detail G of the second (lower) panel 59. The lower panel 59 is wider than the first panel 58 as shown in FIG. 21. The internal surface 71 of the lower panel 59 includes two parallel ‘V grooves 36 to form the second latch tab 74 and an additional tab 75. The lower panel 59 has an alternate triangular corner cut detail 24 for when folding the second latch tab 74 and the additional tab 75 adjacent the second lower tab 78. FIG. 20 shows the hinge holes 28 located in the first hinge tab 62 with dashed line representing the ‘V groove folding guideline 36 in the inner surface 61 of the first panel 58

FIGS. 21 to 24 show the steps in the insertion of the latch frame section 40c to the edge section of the honeycomb core panel 20b. The other frame sections 40 are the same as for the door 100 above, only the latch frame section 40c is different. The latch frame section 40c in cross-section comprises a step (rebate) 43 in the central portion 41.

The step 43 is formed by the central portion 41 comprising a first vertical section 81 extending from the upper flange 42a, a second horizontal section 82 at a mid-portion, and a third vertical section 83 extending to the lower flange 42b. The lower flange 42b is thus wider than the upper flange 42a.

As per above, the frame sections 40 are inserted into the honeycomb core panel 20b. For the latch edge, the first latch tab 64 covers the first vertical section 81, the additional tab 75 covers the second horizontal section 82, and the second latch tab 74 covers the third vertical section 83. The folded tabs secure the frame sections 40 to the honeycomb core panel 20b. FIG. 24 shows the closed panel folds creating a double rebate door.

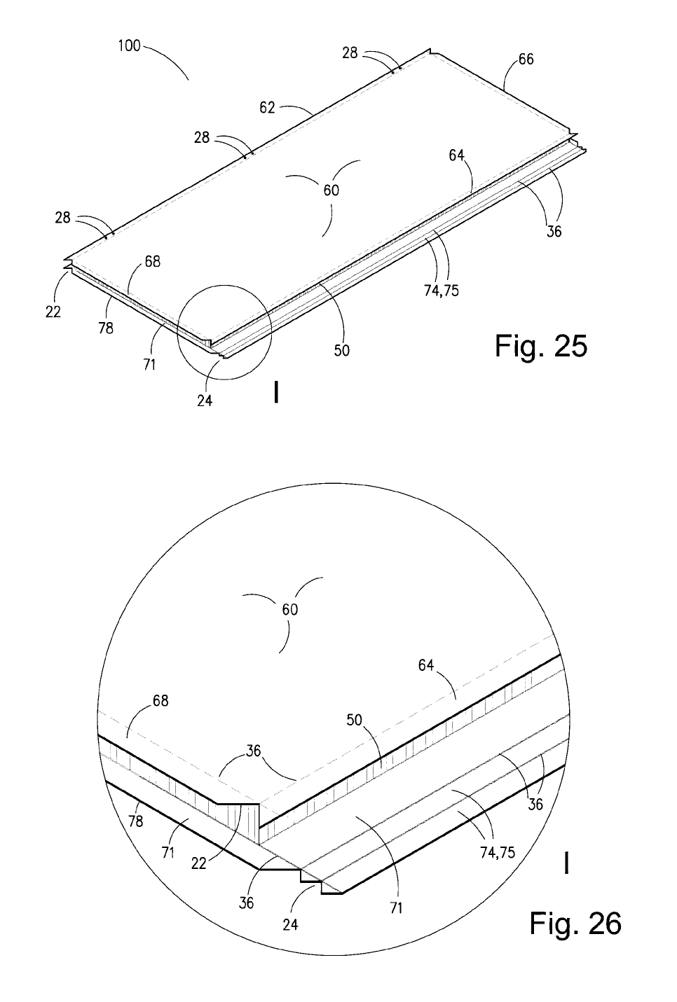

FIGS. 25 and 26 is an isometric view of the honeycomb core 20b of FIG. 17 showing the panel corner cuts and edge tabs. Dashed lines 36 represent the V shaped grooves, door hinge holes 28 with cut out shapes 22 and 24 forming the corner tab folds.

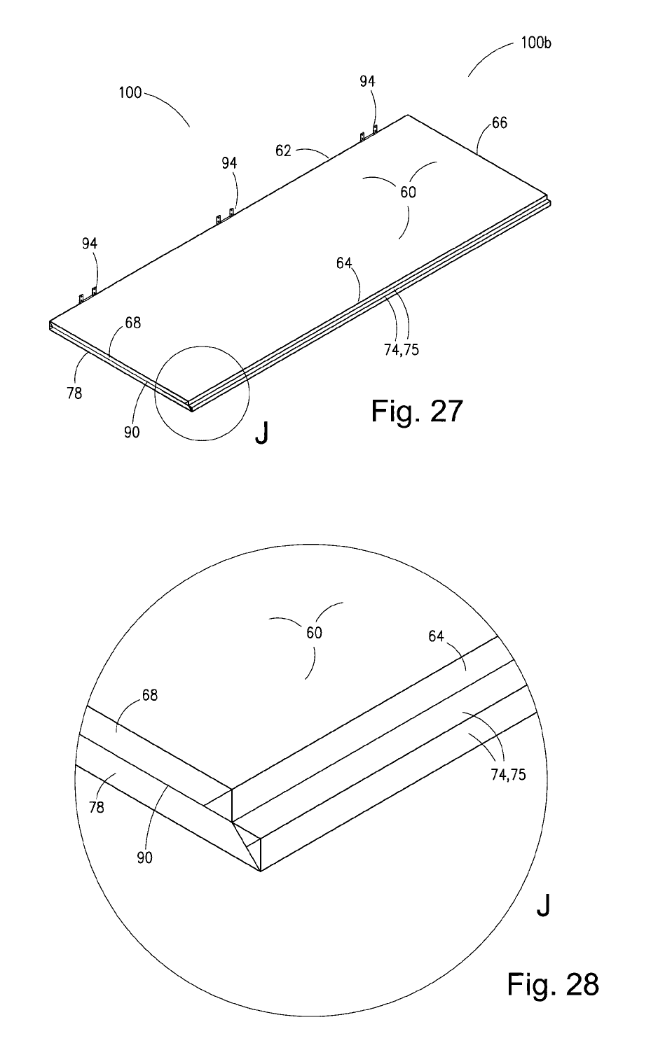

FIGS. 27 and 28 show the formed alternative door 100b with the folded first panel tab 64 meeting with second panel tabs 74 and 75 creating a double rebate door, with folds meeting at the middle 90 of the panel thickness.

The present invention provides an improvement on the conventional door construction by using a prefabricated and pre-finished honeycomb core panel that is cut and V grooved with folded edges that form a substantially seamless door.

The present invention allows for doors to be completely manufactured on a CNC Computer Numerically Controlled machine ensuring greatest efficiency and accuracy.

The present invention also allows for very large doors of high strength that are capable of having a different colour or texture on the inside and outside.

The present invention provides an extremely lightweight door relative to the size due to the nature of material technology.

There are many possible alternative embodiments to the present invention.

The present embodiment provides a door that is formed entirely out of a pre-fabricated and pre-finished single panel of aluminium honeycomb core panel. The honeycomb panel is cut and grooved in such a way to accept an inner frame for structural strength, with edges being folded to lock onto the inner frame.

Whilst preferred embodiments of the present invention have been described, it will be apparent to skilled persons that modifications can be made to the embodiments made.

The panel can alternatively be made from stainless steel or other metal sheet, with an alternate core other than a honeycomb core. As a further alternative, the panel can be made from plastics material core between two sheets of other metals.

The preferred embodiment provides the following advantages:

Completely pre-finished door manufactured from a pre-fabricated material

A door manufactured from a single aluminium honeycomb core panel

Capable of having two different colours and textures inside and outside

Very large up to 2.0 m×4.0 m doors that are high strength

Extremely lightweight doors in comparison to size.

Great thermal properties

Will not swell of distort

Manufacturing process on computer numerical control CNC machine.

According to a first aspect, the present invention provides a door comprising a prefabricated single honeycomb core aluminium panel, such that thickness of the honeycomb panel equals the thickness of the door required.

In a preferred embodiment, the pre-fabricated honeycomb core is sandwiched between upper and lower pre-finished aluminium sheets.

In another preferred embodiment, the pre-fabricated honeycomb core panel comprises edge tabs that are folded from the upper and lower faces respectively, folded to encompass the external door perimeter.

In another preferred embodiment, the pre-fabricated panel is substantially rigid and comprises grooves formed into the inner surface of the upper and lower panels, with grooves being spaced by a distance equal to half width of the panel.

In another preferred embodiment, V grooves are carved into the inner surface of the upper and lower panels, providing a folding guideline and control the folding radius.

In another preferred embodiment, the upper face and lower face folded sections meet at the middle of the panel thickness, and encompass the perimeter of the entire panel.

In another preferred embodiment, the upper and lower corners comprise of triangular cuts at such an angle that the adjacent tabs are substantially contiguous when folded.

In another preferred embodiment, the panel further comprises an inner aluminium frame which is inserted by sliding into the perimeter of the honeycomb core panel from the side.

In another preferred embodiment, the upper and lower panel folds are secured to the inner aluminium door frame section via the hinges that lock the frame to the upper and lower external faces and provide structural strength to the door.

In another preferred embodiment, the panel further comprises at least one flush mount hinge that is screwed into the inner aluminium frame to lock the upper and lower folds with the inner aluminium door frame.

In another preferred embodiment, the panel comprises additional grooves formed in the inner surface along lines parallel to and inwardly spaced from edges of the panel to form side, upper and lower edge tabs which are folded towards each other to form the latch, hinge, upper and lower faces of the door respectively.

In another preferred embodiment, the door comprises of one of the main faces being wider that the other, the wider main face comprising two adjacent edge tabs.

In another preferred embodiment, the two adjacent edge tabs are folded such to form a double rebate at the latch face.

In another preferred embodiment, the honeycomb core aluminium panel door is sufficiently rigid to accept a glass insert panel, and as such can be used for feature doors and front entry doors.

In another preferred embodiment, the external sheets are stainless steel.

In another aspect, the invention provides a door comprising of a single pre-fabricated aluminium honeycomb core panel that is of required door thickness, having upper and lower surfaces that are cut with triangular tabs, V grooved and edge folded to form a pre-finished door with fully enclosed edges.

In another preferred embodiment, the door can be made a much larger size up to 2.0 metres×4.0 metres and is super strong due to pre-fabricated nature of material used.

In another preferred embodiment, the door is extremely lightweight in comparison to conventional doors of equivalent size and strength.

In another preferred embodiment, the door has factory pre-finishing with nano technology and is capable of having the outside surface colour and or texture totally different to the inside surface colour and or texture, whereas the edge folds meet at the middle of the thickness of the door.

In another preferred embodiment, the door is completely waterproof, will not swell or distort, and has great thermal properties.

The invention provides a means for a completely pre-finished door to be manufactured from a pre-fabricated aluminium honeycomb core panel. The relatively lightweight honeycomb panel is manufactured with pre-finished upper and lower faces, having the advantage that each face can be finished in a different colour or texture for inside and outside use.

In a possible modification, the flanges of the frame sections can be omitted. The central section of the frame sections can alternatively comprise hollow sections such as rectangular hollow sections.

1. A door comprising:
a sandwich panel comprising a first panel, a second panel, and a honeycomb core extending between inner surfaces of first and second panels, the first and second panels having edge tabs foldable towards each other,
wherein inner frame sections are disposed at edge sections of the sandwich panel adjacent the honeycomb core and inwardly of the edge tabs, and
wherein the edge tabs are folded towards each other over the inner frame sections.

2. The door of claim 1 wherein fold grooves are formed into the inner surfaces of the first and second panels at the edge sections thereof, the fold grooves being spaced inwardly from edges of the first and second panels and defining the edge tabs in the first and second panels.

3. The door of claim 2, wherein each inner frame section comprises an elongated C-section beam having a central portion and upper and lower flanges, wherein the upper and lower flanges are disposed in the honeycomb core adjacent the respective first and second panels, and wherein the central portion extends perpendicularly between the first and second panels slightly inwardly of the fold grooves.

4. The door of claim 1, wherein said inner frame sections comprise a hinge frame section, a latch frame section, and top and bottom frame sections.

5. The door of claim 4, wherein said inner frame sections comprise mitred cut ends to meet at the corners of the door and to form an inner perimeter frame.

6. The door of claim 1 wherein the edge tabs meet in a contiguous manner at a centre width line.

7. The door of claim 1 wherein the edge tabs are comprised of one tab selected from a group consisting of hinge tabs, latch tabs, upper tabs and lower tabs.

8. The door of claim 7 wherein the latch plate tabs comprise latch deformation outlines and a latch cutout opening, wherein the deformation outlines are punched and deformed into both latch tabs to provide a recess to house a latch plate.

9. The door of claim 1 wherein the corners of the first and second panels include shaped cut outs to provide contiguous folded edges.

10. The door of claim 7 wherein hinge holes are formed in the hinge tabs, with hinges joining the hinge tabs to each other.

11. The door of claim 10 wherein the hinges are attached to the inner frame section at the hinge edge.

12. The door of claim 1 wherein the inner frame section for the latch edge comprises a step in the central portion thereof, wherein latch edge tabs of the honeycomb core cover the step.

13. The door of claim 1 wherein the first and second panels are comprised of rectangular aluminium sheets.

14. The door of claim 1 wherein the honeycomb core is comprised of one of a group consisting of aluminium, polyurethane foam, and polystyrene.

15. A method of forming the door, the method comprising the steps of:
providing a sandwich panel comprising a first panel, a second panel, and a honeycomb core extending between inner surfaces of first and second panels, the first and second panels having edge tabs foldable towards each other,
inserting inner frame sections at edge sections of the sandwich panel adjacent the honeycomb core and inwardly of the edge tabs, and
folding the edge tabs are towards each other over the inner frame sections.

16. The method of claim 15 wherein each inner frame section comprises an elongated C-section beam having a central portion and upper and lower flanges, the method comprising removing honeycomb material for inserting the upper and lower flanges therein.
